(19) United States
(12) Patent Application Publication
(10) Pub. No.: US 2015/0149125 A1
(43) Pub. Date: May 28, 2015

(54) PERFORATED PLATE FOR PRODUCING GRANULES FROM THERMOPLASTIC MATERIAL AND FOR PRODUCING SUCH A PERFORATED PLATE

(71) Applicant: AUTOMATIK PLASTICS MACHINERY GMBH, Grossostheim (DE)

(72) Inventor: Helmuth Meidhof, Grossostheim (DE)

(21) Appl. No.: 14/608,090

(22) Filed: Jan. 28, 2015

Related U.S. Application Data
(63) Continuation of application No. PCT/EP2013/002233, filed on Jul. 29, 2013.

(30) Foreign Application Priority Data
Aug. 1, 2012 (DE) 102012015257.4

(51) Int. Cl. B29C 47/30; B29B 9/06; G06F 17/50; B21D 28/26

(52) U.S. Cl. CPC B29C 47/30; B21D 28/26; B29B 9/06; G06F 17/50; B29K 2101/12
USPC 703/1; 425/464; 29/896.6

(57) ABSTRACT

A perforated plate for producing granulate or microgranulate from a thermoplastic plastic material and a method of manufacturing a perforated plate for producing granulate or microgranulate from a thermoplastic plastic material, wherein the perforated plate comprises a plurality of nozzle bores. The lengths of the nozzle bores are respectively sized such that each nozzle bore of the plurality of nozzle bores allows a substantially uniform flow rate of a melt material.

### CROSS REFERENCE TO RELATED APPLICATIONS

The present patent application is a Continuation application that claims priority to and the benefit of co-pending International Patent Application No. PCT/EP2013/002233 filed Jul. 29, 2013, entitled “PERFORATED PLATE FOR PRODUCING GRANULES FROM THERMOPLASTIC MATERIAL AND METHOD FOR PRODUCING SUCH A PERFORATED PLATE”, which claims priority to DE Application No. 102012015257.4 filed Aug. 1, 2012. These references are incorporated in their entirety herein.

### FIELD

The present embodiments generally relate to a perforated plate for producing granules from thermoplastic material a method of producing such a perforated plate.

### BACKGROUND

A need exists for a perforated plate for producing granules from thermoplastic materials having a multiplicity of die orifices.

A further need exists for a method to product the perforated place for producing granules from thermoplastic material.

The present embodiments meet these needs.

### BRIEF DESCRIPTION OF THE DRAWINGS

The detailed description will be better understood in conjunction with the accompanying drawings as follows:

FIG. 1 shows a perforated plate for microgranulate according to one or more embodiments.

FIG. 2 schematically depicts a section of a perforated plate in the vicinity of a nozzle nest according to one or more embodiments.

FIG. 3 shows a sample temperature contour map of temperatures in a section of a perforated plate in the vicinity of a nozzle nest for the case in which the nozzle bore lengths are uniform.

FIG. 4 depicts a first distribution of speed profiles of melt flows through nozzle bores of a nozzle nest when the nozzle bore lengths are uniform.

FIG. 5 depicts a second distribution of speed profiles of melt flows through nozzle bores of a nozzle nest when the nozzle bore lengths are uniform.

FIG. 6 depicts a nozzle bore nest with adapted nozzle bore lengths according to one exemplary embodiment.

FIG. 7 depicts a distribution of speed profiles of melt flows through nozzle bores of a nozzle nest for the case in which the nozzle bore lengths are adapted according to one exemplary embodiment.

FIG. 8 depicts a sample temperature contour map in a section of a perforated plate in the vicinity of a nozzle nest for the case in which the nozzle bore lengths are adapted according to one exemplary embodiment.

FIG. 9 is a diagram of steps of a method for determining nozzle bore lengths for a perforated plate according to one exemplary embodiment.

FIG. 10 depicts a section of a perforated plate in the vicinity of a nozzle nest according to another embodiment.

The present embodiments are detailed below with reference to the listed Figures.

### DETAILED DESCRIPTION OF THE EMBODIMENTS

Before explaining the present apparatus and method in detail, it is to be understood that the apparatus and method are not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The invention relates to a perforated granulate plate, a method for calculating bore lengths of a perforated granulate plate, and a method for manufacturing a perforated granulate plate.

In order to produce granulates out of a thermoplastic plastic material, in particular polymers such as polyethylene or polypropylene, frequently granulating devices are used in which extruded, molten plastic material is pressed through nozzle bores of a perforated plate into a cooling fluid such as water that is contained in a cutting chamber so that the emerging molten material is made to set as quickly as possible by cooling. The cutting chamber also contains a cutter arrangement with cutters that sweep across the openings of the perforated plate and cut the strands of material so that pellets are formed.

Recently, microgranulates—a term that denotes granulates with dimensions of less than or equal to 1.0 mm—have seen increasing use in a wide variety of application fields such as micro-injection molding, rotation injection molding, packing, or compounding/masterbatches. Most often, microgranulation is performed using specially produced perforated plates that are equipped with a large number of nozzle bores. The nozzle bores are grouped in nests of bores, also referred to as clusters, in which a large number of nozzle bores are arranged in close proximity. A large number of bore nests, in turn, are arranged in one or more constituent circles of the perforated plate.

Granulating devices of this kind are known, for example, in the form of the underwater granulators of the SPHERO® series by Automatik Plastics Machinery GmbH.

The different temperatures that prevail on and in the perforated plate cause a distinct temperature profile to occur in the perforated plate. Hotter zones of the perforated plate—for example in the immediate vicinity of a heating conduit in which a heat transfer oil at a temperature of 240 degrees Celsius circulates in order to heat the perforated plate or in the vicinity of the melt supply in which the melt is supplied to the perforated plate at a temperature of 230 degrees Celsius, for example—are located next to colder zones such as the opening side of the perforated plate, which is in contact with and bathed by the cooling fluid, which can have a temperature of 70 degrees Celsius, for example.

The cooling effect of the cooling fluid in this case is particularly pronounced in the vicinity of the nozzle nests and nozzle bores, respectively, since in these regions, the contact surface of the perforated plate is in particularly intensive contact with the cooling fluid.

In this connection, the cooling effect can be observed to affect the nozzle bores of a nozzle nest differently, possibly making nozzle bores located in the periphery region of the nozzle nest colder than the centrally located nozzle bores.

Due to the different temperatures that prevail in the vicinities of different nozzle bores of a nozzle nest, the melt quantity that is contained in the respective nozzle bores is thus cooled differently in a corresponding fashion. In fact, the melt flows more slowly in cooler nozzle bores and has a correspondingly lower flow rate than in warmer nozzle bores.

The uneven distributed flow rate of melt material through the bores of a nest result in microgranulate being formed with a correspondingly broad distribution of granule sizes.

One possibility for increasing the uniformity of the flow rate for different nozzle bores is to arrange them in concentric rings, which makes it easier to calculate the interaction between adjacent nozzle bores and for the individual rings and produces a relatively easy-to-calculate and at least essentially uniform temperature there, which tends to reduce the distribution of the granule sizes in a rather desirable fashion. This positive effect of the ring-like arrangement, however, is usually not enough to reduce the above-explained interactions and the associated undesirable effects, e.g. on the distribution of granule sizes, to a minimum all by itself.

Another possible occurrence is that melt material in the outer, cooler nozzle bores can cool to the point that it is no longer fluid and hardens. The affected bores “freeze” and this correspondingly reduces the number of nozzle bores of the perforated plate that are operational and from which melt material emerges that is available for granulation. The freezing of nozzle bores therefore leads to a reduction in the granulation output and/or to an undesirable increase in the average of the granule size distribution of the pellets because a freezing of individual nozzle bores increases the flow rate through the remaining open nozzle bores.

One object of the invention, therefore, is to disclose a perforated plate that overcomes the above-mentioned disadvantages.

Another object of the invention is to disclose a perforated plate that makes it possible to produce granulate, in particular microgranulate, with a reduced distribution of the granule sizes.

Another object of the invention is to disclose a perforated plate, in which the occurrence of frozen nozzle bores is prevented to the greatest extent possible or is at least reduced.

This and other objects of the present invention are attained by means of a perforated plate for producing granulate out of a thermoplastic plastic material, a computer-implemented method for determining nozzle bore lengths for a perforated plate in order to produce granulate out of thermoplastic plastic materials, and a method for manufacturing a perforated plate for producing granulate out of a thermoplastic plastic material.

In a first aspect, the present invention relates to a perforated plate for producing granulate out of a thermoplastic plastic material, having a large number of nozzle bores, in which the lengths of the nozzle bores are respectively dimensioned so that the nozzle bores have an essentially uniform flow rate of melt material.

According to the invention, an uneven flow rate of melt material through nozzle bores can essentially be compensated for by varying the lengths of the respective nozzle bores and thus the hydraulic resistance produced by the nozzle bores. The most uniform possible flow rate distribution can be achieved by means of nozzle bores that are correspondingly varied and have different lengths.

In this way, it is, in particular, possible to avoid individual nozzle bores having a significantly lower flow rate of melt material than other nozzle bores, thus reducing the risk of a freezing of bores that exists due to a low flow rate of melt material.

The perforated plate can be a perforated plate for producing microgranulate out of thermoplastic plastic material, which has a plurality of nozzle nests that are arranged in at least one constituent circle of the perforated plate.

Each nozzle nest can have a plurality of nozzle bores, which can have a uniform bore diameter. The nozzle bores can have a diameter of less than 1.0 mm, but can be in the range from 0.2 mm to 0.8 mm.

The bore length can in particular be shortened by providing a pre-drilled bore with a larger diameter, so that the nozzle bore is countersunk.

Alternatively or in addition, a segment thickness can be changed or the topology of the nozzle nest can be changed in some other way in order to obtain a nozzle bore with a shorter nozzle bore length. In particular, the topology can be described by a stepped surface or a spherical surface, which describes one side of the nozzle nest that is oriented away from a cutter arrangement and/or toward an inlet conduit.

The bore lengths can vary by a few tenths of a millimeter.

The length of the nozzle bores can in particular be determined with the aid of a three-dimensional simulation by means of computational fluid dynamics (CFD); the simulation is can be embodied for a predetermined, desired operating state and/or for a range around the desired operating state.

In a second aspect, the present invention relates to a computer-implemented method for determining nozzle bore lengths for a perforated plate for producing granulate out of thermoplastic plastic materials, where the perforated plate has a plurality of nozzle bores.

The method can include creation of a model that describes the perforated plate at least in the region of a subset of the plurality of nozzle bores.

The method can include presetting of operating parameters for at least one desired operating state.

The method can include execution of a computer-implemented calculation and/or simulation of a flow of melt material through the subset of nozzle bores by using the model, in order to determine a flow rate of melt material for each nozzle bore of the subset.

The method can include changing of the lengths of the nozzle bores in order to produce a more uniform flow rate.

The term “subset of nozzles bores” can describe a number of nozzle bores that are arranged adjacent to one another in the perforated plate and/or that are embodied in a definable area of the perforated plate. The subset of nozzles bores can be a subset of all of the nozzle bores of the perforated plate. It likewise possible for the method to take into account all of the nozzle bores of the perforated plate, in which case, the subset of nozzles bores corresponds to the entire plurality of nozzle bores.

The method can be used to determine nozzle bore lengths for a perforated plate for producing microgranulate, where the perforated plate has a plurality of nozzle nests that are arranged in at least one constituent circle of the perforated plate.

The term “subset of nozzle bores” can also refer to the nozzle bores of at least one of the nozzle nests.

The computer-implemented simulation is carried out as a three-dimensional simulation by means of computational fluid dynamics CFD using a processor or a plurality of processors.

The three-dimensional simulation can describe the geometry and the material properties of the perforated plate relating to the transmission of heat, at least in the region of the subset of nozzle bores. The model can describe a nozzle nest or several nozzle nests as the subset of nozzle bores. It is likewise possible to use a three-dimensional simulation for the entire perforated plate.

The operating parameters can be viscosity parameters for the melt material, a temperature of the melt material in a supply line region, a perforated plate heating temperature, and/or a cooling fluid temperature.

The flow rate of melt material through a nozzle bore can be determined by determining the speed with which the melt material flows through the nozzle bore. In this case, a speed profile can be determined, for example, by means of the diameter of the at least one nozzle nest and/or the average speed by means of the diameter.

The reference value can have a predetermined setpoint value for the flow rate of melt material, a value of the flow rate of melt material that is determined for a nozzle bore that has been selected as the reference, or an average of the flow rate of melt material through all of the nozzle bores of the subset of nozzle bores. In embodiments, a nozzle bore that is located centrally in the nozzle nest is selected as the nozzle bore.

The length of a nozzle bore can be shortened if the flow rate of melt material determined for the nozzle bore is less than the reference value.

The length of a nozzle bore can be changed with a fixed, predetermined increment. Preferably, the length of a nozzle bore is changed with a changing value. In particular, with an iterative determination of optimum nozzle bore lengths through repeated calculation and/or simulation of the flow rate of melt material through the nozzle bores, an increment that decreases for each iteration.

A quality criterion is determined that is representative for a deviation of the flow rates of melt material through the nozzle bores of a nozzle nest. The quality criterion can in be based on: a minimum value and/or a maximum value of the determined flow rates of melt material through the nozzle bores; a difference between the maximum value and the minimum value of the determined flow rates of melt material through the nozzle bores; or a sum of the squares of the differences of the determined flow rates of melt material through the nozzle bores from an average of the determined flow rates of melt material.

The quality criterion can be used to compare to a preset criterion in an iterative determination of nozzle bore lengths, with the iteration being interrupted when the quality criterion meets the criterion.

The method can be used to determine suitable nozzle bore lengths for a perforated plate.

The method can be a component of a method for manufacturing a perforated plate for producing microgranulate out of thermoplastic plastic materials, with the perforated plate being produced in accordance with the determined nozzle bore lengths.

The perforated plate can be part of a hot-cut granulating device.

At the applicant's technical center, tests were performed on the nozzle length compensation according to the invention.

In these tests, microgranulate composed of low density polyethylene (LDPE) with 5 percent white masterbatch was produced using a SPHERO 50™ underwater granulating system with a material flow rate of 16 kg/h through perforated plate with 20 bores. An associated cutter support can be used with 6 cutters rotating at a speed of 3500 rpm. The particle size distribution thus achieved was determined using a CAMSIZER™ from Retsch Technology GmbH.

Different production scenarios were tested with otherwise uniform testing conditions.

Starting Situation:

All 20 nozzle bores with a nozzle diameter of 0.8 mm were uniformly provided with a cylindrical nozzle length of 5 mm.

This group of nozzle bores yielded an average granulate diameter Mv3=1201 μm; standard deviation Sigma3=106 μm.

Changes to the starting situation according to a first computational fluid dynamics CFD simulation according to the invention:

With 10 nozzle bores, the cylindrical nozzle length was reduced to 4.6 mm; the remaining 10 nozzle bores remained at 5 mm.

This combination of 20 nozzles of different lengths yielded an average granulate diameter Mv3=1214 μm; with a standard deviation Sigma3=92 μm.

Further changes according to a second computational fluid dynamics CFD simulation according to the invention:

For this simulation, six nozzle bores remained at a cylindrical nozzle length of 5 mm, 8 nozzle bores had a cylindrical nozzle length of 4.6 mm, and the remaining 6 nozzle bores were shorted to a cylindrical nozzle length of 4.2 mm.

This second computational fluid dynamics CFD simulation yielded an average granulate diameter Mv3=1219 μm; standard deviation Sigma3=89 μm.

In all, the following results were achieved according to the invention:

Shortening the cylindrical nozzle length decreases the pressure drop at the corresponding nozzle bore and slightly increases the flow rate per nozzle bore, thus also slightly increasing the average granulate diameter. The shortening can be compensated for as needed by slightly increasing the cutter speed. For the sake of reproducible (constant) testing conditions, however, this was not done in the present case, in order to identify the direct effects of the nozzle length compensation—without further testing variables.

The nozzle length compensation according to the invention achieves a significant reduction in the standard deviation, i.e. with an almost constant pellet diameter, the size distribution of pellets becomes significantly narrower and thus the flow rate per nozzle bore also becomes significantly more uniform.

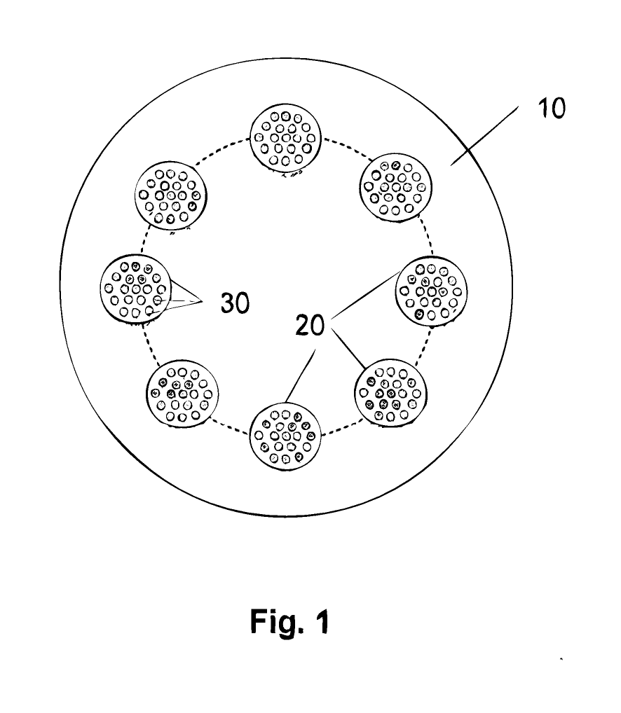

FIG. 1 shows a perforated plate for microgranulate according to one or more embodiments.

The perforated plate 10 for producing microgranulate out of thermoplastic material is depicted with a melt outlet side of the perforated plate 10.

A plurality of nozzle bores 30 are embodied in the perforated plate 10, which can be grouped in bore nests 20, also referred to as clusters. The bore nests 20 can be arranged in one or more constituent circles of the perforated plate 10.

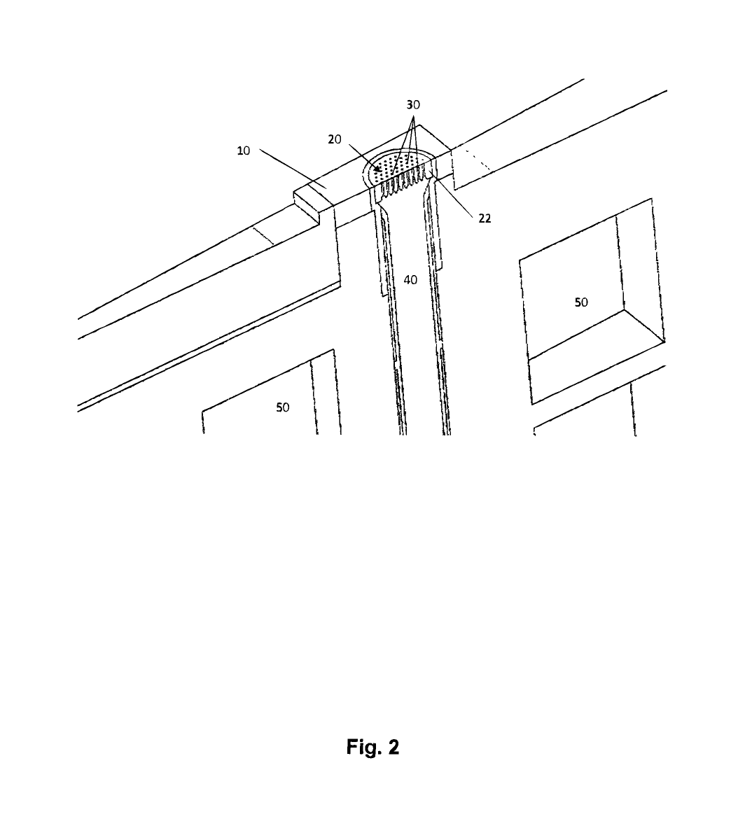

FIG. 2 schematically depicts a section of a perforated plate in the vicinity of a nozzle nest.

This Figure shows a section in the vicinity of a nozzle nest 20 of a perforated plate 10 for producing microgranulate out of thermoplastic plastic material.

A plurality of nozzle bores 30 are embodied in the nozzle nest 20. The plurality of nozzle bores 30 can each have the same bore diameter, which can be in the range from 0.1 mm to 1.0 mm.

The plurality of nozzle bores 30 can be arranged in close proximity in the nozzle nest 20. The distance between two adjacent nozzle bores can thus be less than 7 times, the bore diameter of the plurality of nozzle bores 30. This orientation achieves a compact packing and it is possible to provide the perforated plate 10 with a very large number of nozzle nests 20, each with a large number of nozzle bores 30.

The nozzle nest 20 can be embodied as an insert 22 that is inserted into a perforated plate body in order to form the perforated plate 10. It is likewise possible to embody the perforated plate 10 of a single piece and to embody the nozzle nest in the one-piece body of the perforated plate 10.

The plurality of nozzle bores 30 in the nozzle nest 20 can be distributed in irregular or regular fashion, for example regularly distributed in concentric circles or in a triangular, rectangular, or hexagonal arrangement.

The perforated plate 10 can be provided with a supply conduit 40 via which hot melt material is supplied to the nozzle nest 20.

Other conduits 50 are shown that are embodied in the perforated plate 10 and serve to convey a heat transfer fluid in order to control the temperature of the perforated plate 10.

During operation with the perforated plate 10, the hot melt material is conveyed via the supply conduit 40 to the nozzle nest 20, pushed through the plurality of nozzle bores 30 of the nozzle nest 20, and pressed through the outlet openings of the plurality of nozzle bores 30 into a cooling fluid such as water.

The outlet side surface of the perforated plate 10, particularly in the vicinity of the nozzle nests 20, is therefore in intimate contact with the cooling fluid, which can, for example, have a temperature of 70 degrees Celsius. This contact with cooling fluid produces a flow of thermal energy from the hot perforated plate 10 into the cold cooling fluid, which cools the perforated plate 10 locally, especially in the region of the nozzle nests 20, which in particular affects the temperature of the plurality of nozzle bores 30.

At the same time, the inner walls of the plurality of nozzle bores 30 of the nozzle nests 20 are in intimate contact with the hot melt material flowing through the plurality of nozzle bores 30, which transmits a part of the thermal energy that it contains to the respective nozzle bores 30 via their inner walls. In this context, it is necessary to take into account the fact that a nozzle bore 30 located in the center of the nozzle nest 20 is completely surrounded by other nozzle bores 30, whereas for a nozzle bore 30 located at the edge of the nozzle nest 20, there are no additional nozzle bores located to the outside of it.

In embodiments, the plurality of nozzle bores 30 can all have the same geometry and in particular, have the same diameter and the same length. In this case, the heat dissipated from a nozzle bore 30 located in the center of the nozzle nest 20 feeds a smaller volume of the nozzle nest 20 and consequently heats the latter more intensely than does a nozzle bore 30 located at the edge of the nozzle nest 20. At the same time, the portion of the surface that is in contact with the cold cooling fluid that is allotted to a nozzle bore 30 located at the edge of the nozzle nest 20, because of the smaller number of adjacent nozzle bores, is greater than that for a nozzle bore 30 located in the center of the nozzle nest 20. As a result, the nozzle bores 30 at the edges of the nozzle nest are more intensely cooled and have a lower temperature than nozzle bores 30 in the center of the nozzle nest 20.

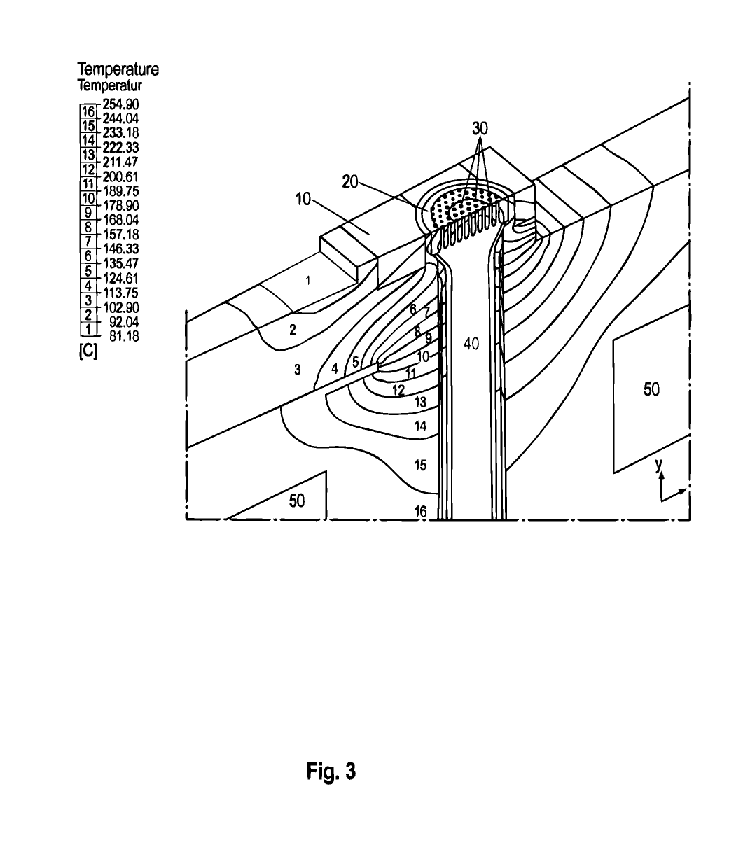

This advantageous feature is shown by way of example in FIG. 3, which shows the result of a simulation presenting a temperature contour map around the nozzle nest 20 and the part of the perforated plate 10 surrounding the nozzle nest 20.

FIG. 3 shows a sample temperature contour map in a section of a perforated plate in the vicinity of a nozzle nest for the case in which the nozzle bore lengths are uniform.

The central region of the nozzle nest 20 can have a higher temperature than the edge region.

The different temperatures of the plurality of nozzle bores 30 result in the fact that melt material that flows through a nozzle bore 30 located at the edge of the nozzle nest 20, due to the relatively colder inner wall, is more intensely cooled than is the case for melt material that flows through a nozzle bore 30 located in the center of the nozzle nest, due to the relatively warmer nozzle bore in the latter case.

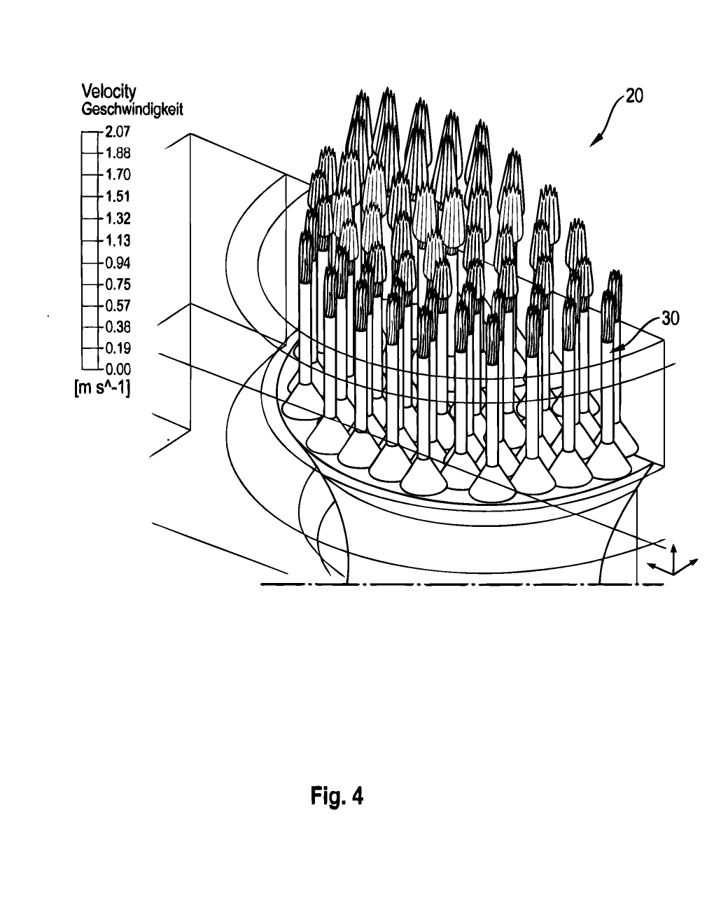

The different cooling results in the melt material assuming different viscosities in the different nozzle bores and correspondingly, flowing at different speeds. This is shown, for example, in FIG. 4, which shows the result of a simulation of the flow of melt material through the nozzle nest 20.

FIG. 4 schematically depicts a first distribution of speed profiles of melt flows through nozzle bores of a nozzle nest for the case in which the nozzle bore lengths are uniform.

For each nozzle bore 30, the vectors are shown for the speed with which melt material flows through and emerges from the respective nozzle bores 30.

It is clear that the speed with which the melt material flows through a nozzle bore 30 located centrally in the nozzle nest 20 is the highest and the speed decreases as nozzle bores are located closer to the edge of the nozzle nest 20, as is clear from the different lengths and widths of the speed vectors.

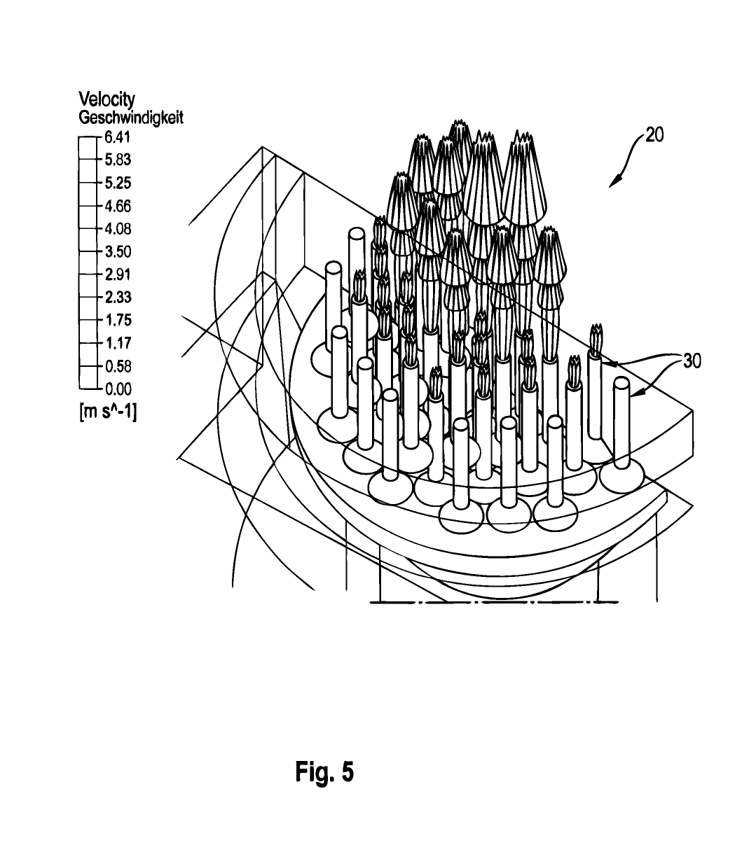

FIG. 5 schematically depicts a second distribution of speed profiles of melt flows through nozzle bores of a nozzle nest for the case in which the nozzle bore lengths are uniform.

This Figure shows another result of another simulation of the flow of melt material through the nozzle nest 20.

The plurality of nozzle bores 30 located at the edge of the nozzle nest 20 have cooled to the point that the melt material is no longer flowing and the plurality nozzle bores 30 located at the edge have “frozen.” In this embodiment, no speed vectors are visible for the affected nozzle bores 30.

The speed of the melt material increases steadily toward the center of the nozzle nest 20 and there is a visible, large difference in the speed with which melt material flows through and emerges from the individual nozzle bores that have not frozen.

The invention therefore includes embodiments that vary the lengths of nozzle bores and adapt them so that an essentially uniform flow rate of melt material is achieved.

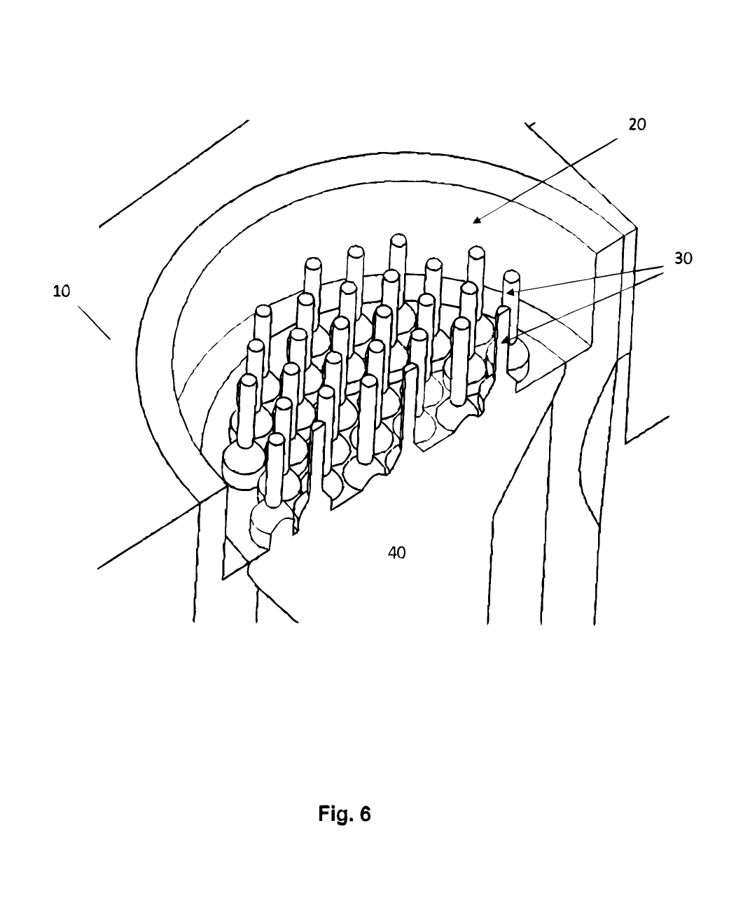

FIG. 6 schematically depicts a nozzle bore nest with adapted nozzle bore lengths according to one or more embodiments.

In this example, the plurality of nozzle bores 30 can be countersunk with pre-drilled bores so that the pre-drilled bores countersink the nozzle bores 30 in such a way that different nozzle bore lengths are produced for different nozzle bores 30.

The nozzle bores 30 located at the edge of the nozzle nest 20 can be embodied with a deeper pre-drilling so that for the nozzle bores 30 located at the edge of the nozzle nest 20, a shorter nozzle bore length is produced than for nozzle bores located in the center of the nozzle nest 20.

Shortening the nozzle bore length reduces the hydraulic resistance of the affected nozzle bore 30 so that it presents less flow resistance to the melt flow. The melt flow can therefore flow more quickly through the shortened nozzle bore 30.

Ideally, the nozzle bore length is dimensioned so that the resulting adapted hydraulic resistance can compensate as optimally as possible for the influence produced by the temperature differences. Through a suitable selection of nozzle bore lengths for the nozzle bores 30 of a nozzle nest 20, it is possible to achieve a flow rate of melt material through the nozzle bores 30 that is essentially uniform for all of the nozzle bores 30 of the nozzle nest 20.

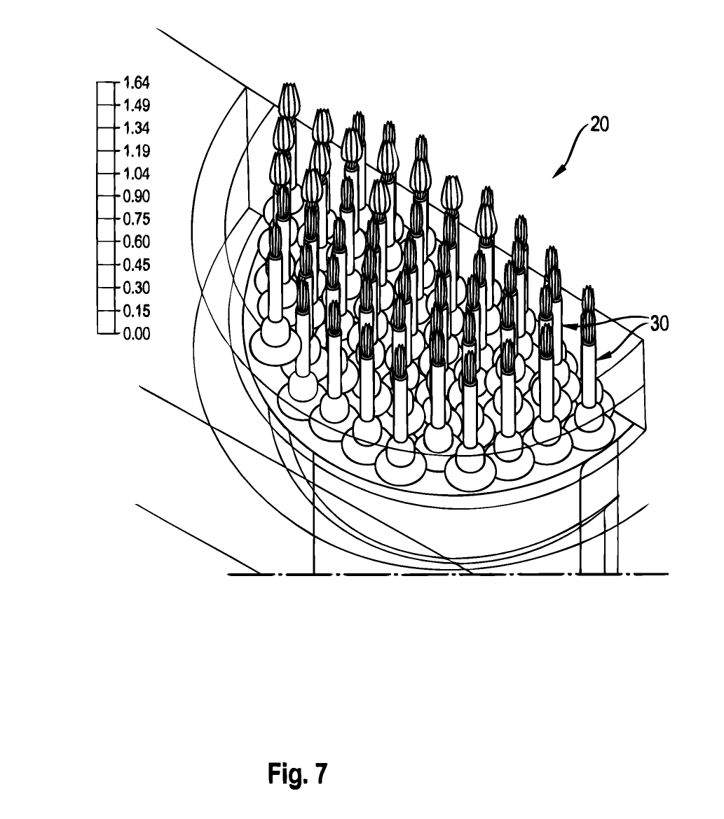

FIG. 7 schematically depicts a distribution of speed profiles of melt flows through nozzle bores of a nozzle nest for the case in which the nozzle bore lengths are adapted according to one or more embodiments.

The speed vectors of the melt material are essentially the same for all of the nozzle bores 30 of the nozzle nest 20. This uniformity of speed vectors was achieved by virtue of the fact that, the nozzle bore lengths, particularly of the nozzle bores 30 located at the edge of the nozzle nest 20, were reduced by a correspondingly significant degree so that the nozzle bore lengths of the nozzle bores 30 located at the edge are adapted and shortened to such an extent that the best possible temperature compensation has been achieved.

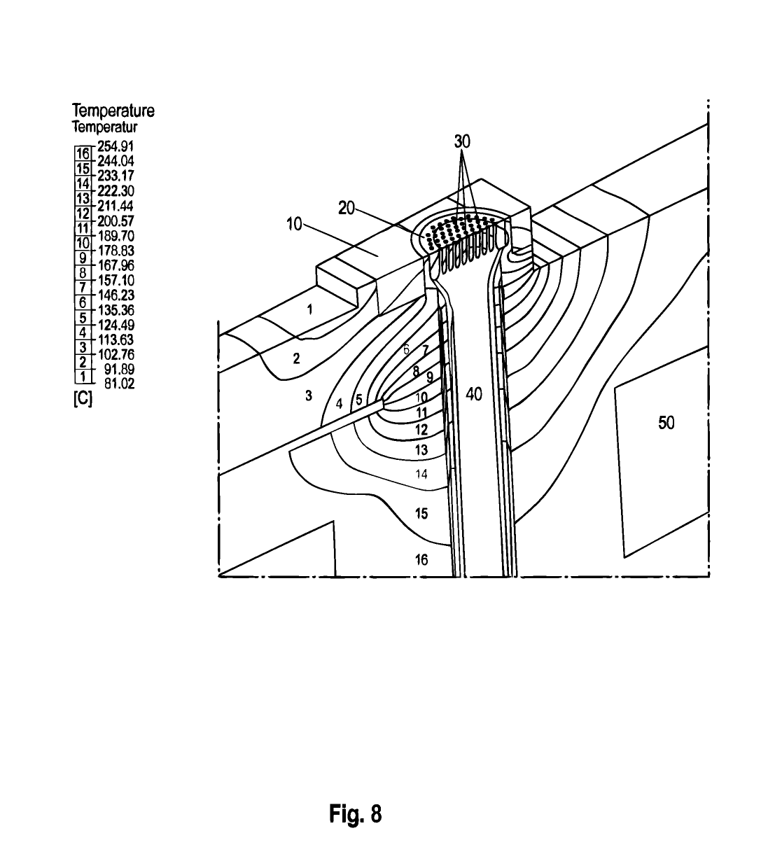

FIG. 8 shows a sample temperature contour map in a section of a perforated plate in the vicinity of a nozzle nest for the case in which the nozzle bore lengths are adapted according to one or more embodiments.

As shown in the temperature contour map, with adapted nozzle bore lengths, a flatter temperature gradient occurs throughout the nozzle nest 20. In addition, the temperature differences between the edge region and the center of the nozzle nest 20 are less than in the case shown in FIG. 3, which has no compensation through adaptation of nozzle bore lengths.

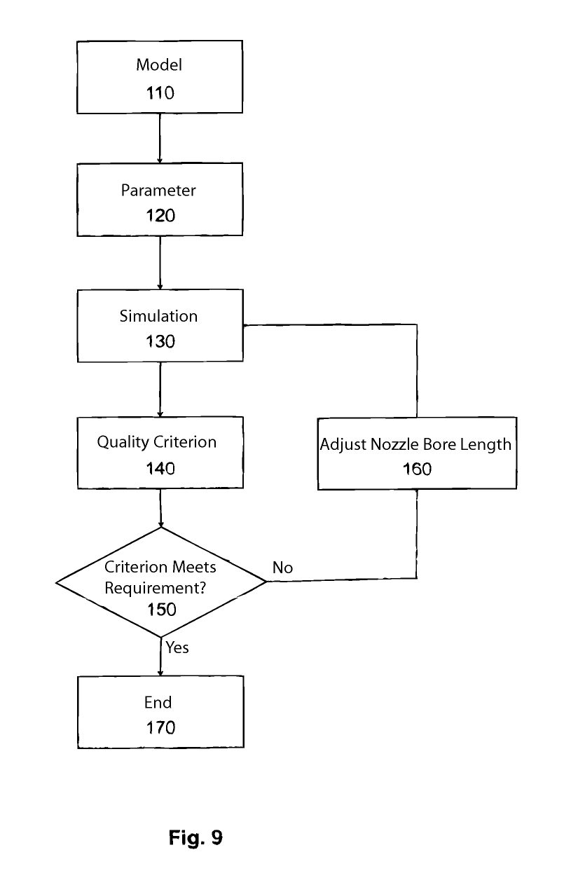

In order to determine the lengths that the individual nozzle bores 30 should have so as to achieve the desired compensation, a method for determining nozzle bore lengths for a perforated plate can be used, which is shown in FIG. 9.

FIG. 9 shows a method for determining nozzle bore lengths for a perforated plate according to one exemplary embodiment.

In the method, which is executed in the form of software on a computer, first a simulation model is produced in a step 110. The simulation model serves as a calculation and/or simulation model, and describes the geometry and properties of the perforated plate. In particular, the simulation model describes the number and spatial arrangement of the nozzle bores 30 in the nozzle nest 20 as well as the geometry of the nozzle bores 30 themselves, such as the diameter and length of the nozzle bores. The simulation model can also describe the thermal behavior of the materials of the perforated plate. In this connection, it is possible for the model to describe only the region of a nozzle nest. This regional description can in particular be possible if all of the nozzle nests 20 of the perforated plate 10 are subject to the same conditions, for example, if all of the nozzle nests 20 are located on the same constituent circle of a rotationally symmetrical perforated plate 10. Alternatively, it is also possible for the simulation model to describe the entire perforated plate 10 or for the simulation model to describe a region of the perforated plate 10 with a plurality of nozzle nests 20.

In another step 120, the parameters are established that are required for the calculation and/or simulation. These parameters can in particular be parameters of a desired operating state for which the perforated plate is to be designed. Predeterminable parameters can in particular include viscosity parameters for the melt material, a temperature of the melt material in a supply region, a perforated plate heating temperature, or a cooling fluid temperature.

Based on the model and the parameters, in step 130, a computer-aided calculation and/or simulation is carried out in order to determine how the melt material is flowing through the nozzle nest 30. In this case, preferably a three-dimensional simulation is carried out using computational fluid dynamics. In this way, for each nozzle bore, a determination is made as to which flow rate of melt material through the individual nozzle bores is produced. The flow rate in this case can be directly determined as a mathematical value or can be derived from the flow speed of the melt material.

Based on the result of the calculation and/or simulation, the lengths of the nozzle bores are adapted in a step 160. In this case, for nozzle bores 30 that have a low or excessively low flow rate of melt material, the nozzle bore lengths can be reduced. Alternatively or in addition, for nozzle bores 30 that have a high or excessively high flow rate of melt material, the nozzle bore lengths can be increased. The calculation procedure would then have to be carried out with a corresponding new (e.g. longer) bore. This calculation can happen for all of the nozzle bores 30 or for only part of the nozzle bores 30. It is also possible to change the length of only one nozzle bore 30.

A reference value can be used in order to determine which nozzle bore 30 should be changed in length. If the flow rate of melt material determined for a nozzle bore deviates from the reference value by more than a predetermined amount, then the determination is made that the length of the nozzle bore must be changed. In this case, a predetermined setpoint value for the flow rate of melt material, a value of the flow rate of melt material that is determined for a nozzle bore located in the center of the nozzle nest, or an average of the flow rate of melt material of all of the nozzle bores of the nozzle nest can be used as the reference value.

In step 160, the nozzle bore lengths can be changed with a predetermined increment. With an iterative method, the increment can preferably be reduced with each iteration. Alternatively, the length change that is to be performed on a nozzle bore 30 can also be calculated as a function of how much the flow rate through the nozzle bore 30 deviates from the reference value.

From step 160, the method can return to step 130 in order to execute a new calculation and/or simulation with the nozzle bore lengths. It is thus possible in an iterative fashion, through repeated simulation, to arrive at the most optimum possible determination of the nozzle bore lengths.

In step 140 it is also possible to determine a quality criterion that is representative for a deviation of the flow rates of melt material through the nozzle bores of a nozzle nest. The quality criterion can be based on: a minimum value and/or a maximum value of the determined flow rates of melt material through the nozzle bores, a difference between the maximum value and the minimum value of the determined flow rates of melt material through the nozzle bores, or a sum of the squares of the differences of the determined flow rates of melt material through the nozzle bores from an average of the determined flow rates of melt material. In this way, the quality criterion can be a measure for how good the compensation is that is achieved by means of the length change.

In step 150, a quality criteria comparison is made, that is the flow rates are compared to a predeterminable criterion in order to determine whether the compensation sufficiently meets the stipulated requirements. If this is not the case, then the steps 160, 130, 140, and 150 are iteratively repeated until the criterion is met or the process is interrupted by a user.

If it is determined in step 150 that the quality criterion meets the stipulated criterion, then the method switches to step 170 and ends.

The determined nozzle bore lengths can then be output, for example in order to produce a perforated plate based on the obtained data.

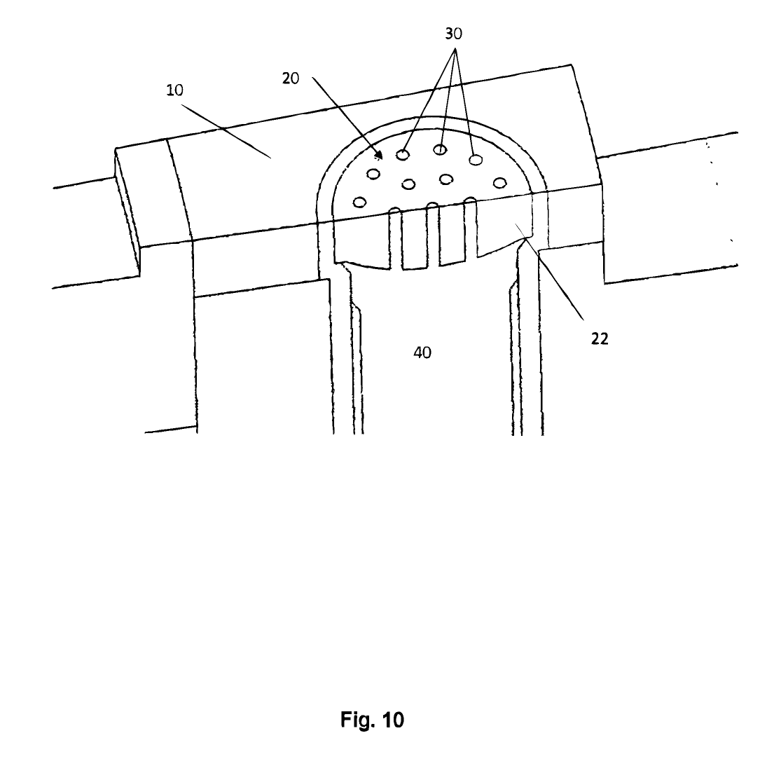

As described above with regard to FIG. 6, the lengths of the plurality of nozzle bores 30 are adapted by providing pre-drilled bores that countersink the nozzle bores 30 in such a way that the nozzle bore lengths that are provided for the respective nozzle bores 30 are produced. Alternatively or in addition, it is likewise possible to change a segment thickness of a nozzle nest or to change the topology of the nozzle nest in some other way. This countersinking will be described below with reference to FIG. 10.

FIG. 10 schematically depicts a section of a perforated plate in the vicinity of a nozzle nest according to another embodiment.

This Figure shows a section in the vicinity of a nozzle nest 20 of a perforated plate 10 for producing microgranulate out of thermoplastic plastic material according to another embodiment.

The nozzle nest 20 can be embodied in the form of an insert 22 that can be inserted into a perforated plate base body in order to form the perforated plate 10.

The plurality of nozzle bores 30 of the nozzle nest 20 are embodied in the insert 22. The insert 22 in the example is embodied so that the insert 22 is flat on the side oriented toward the cutter arrangement and is embodied as convex on the side oriented toward the supply conduit 40. This produces a topology of the insert 22 based on which nozzle bores 30 in the center have a length that is greater than the length of nozzle bores that are embodied at the edge of the insert 22.

In this case, the side of the insert 22 oriented toward the supply conduit 40 can, for example, be machined by a machining center that machines the affected surface as a free-form surface in order to obtain the corresponding determined nozzle lengths.

The surface in this case can have a stepped profile or, as shown in this Figure, can have an essentially linear profile. The profile can be described by an aspherical surface. Alternatively, the profile can also be described by a spherical surface, where the parameters of the spherical surface can be selected so that the determined adapted lengths of the nozzle bores that are to be achieved can be approximated as closely as possible. Particularly in the case of a spherical surface, the machining can also be carried out by means of grinding.

The plurality of nozzle bores 30 with the adapted nozzle bore length can be produced in the nozzle nest 20 in this way without having to provide pre-drilled bores in the affected nozzle bores.

As described above, the change and adaptation of the lengths of the nozzle bores can improve the uniformity of the flow rate of melt material through the nozzle bores.

Alternatively, it is likewise conceivable, in order to increase the uniformity of the flow rate for different nozzle bores, to change the nozzle diameter of individual nozzle bores or to correspondingly adapt it to the temperature profile.

It is possible, for example, through a corresponding simulation analogous to the method described with reference to FIG. 9, to determine a respective adapted bore diameter for all of the nozzle bores of a nozzle nest in such a way that an optimally uniform or at least sufficiently uniform flow rate of melt material through the nozzle bores is produced.

Since a change of the diameter in the range of a few hundredths of a millimeter can already produce a very significant change in the hydraulic resistance of the affected nozzle bore, the parameter of the nozzle diameter is very sensitive with regard to adjustability.

For an adapted perforated plate, it would therefore be necessary to produce the nozzle bores precisely and with a large number of respectively adapted, only slightly different diameters. Since this is significantly harder to implement from a production standpoint than changing and adapting the nozzle bore lengths, which is easy to control from a production standpoint, changing and adapting the nozzle bore lengths is preferable to changing and adapting the nozzle diameters.

Particularly in the case of large nozzle nests with a large number of nozzle bores and/or in the case of perforated plates that are embodied as relatively thin in the region of the nozzle bores and whose nozzle bores have correspondingly short nozzle bore lengths, it can be advantageous to adapt both the diameter and the length of the respective nozzle bores.

It is thus possible, for example, to first determine an adapted length of a nozzle bore based on an initial diameter of the nozzle bore. If the determined length assumes a value that is greater than a desired maximum length of a nozzle bore or a value that is less than a minimum length of a nozzle bore, then the initial diameter can be increased or reduced and based on this, an adapted length of the nozzle bore can be determined again.

It is this possible to achieve an embodiment in which the lengths of the nozzle bores do not differ by a possibly undesirable amount. In this case, if there are only a limited number of different diameters provided for the possible diameters of the nozzle bores, for example 2, 3, 4, or 5 different diameters, then it is possible to provide for this limited number of diameters, corresponding tools such as drill bits that permit a precise production of this limited number of different diameters. It is thus possible, without too great an amount of production complexity, to produce perforated plates whose nozzle bores are adapted both in their diameter and in their length in order to achieve the most uniform possible flow rate of melt material through the nozzle bores.

While the invention has been described here with regard to perforated plates for producing microgranulate, the present invention is not limited in this way. Instead, the invention can also be used in other kinds of perforated plates which have a plurality of nozzle bores, which do not necessarily have to be arranged in nozzle nests.

While these embodiments have been described with emphasis on the embodiments, it should be understood that within the scope of the appended claims, the embodiments might be practiced other than as specifically described herein.

What is claimed is:

1. A perforated plate for producing a granulate or a microgranulate from a thermoplastic plastic material comprising a plurality of nozzle bores, wherein each nozzle bore of the plurality of nozzle bores comprises a substantially uniform bore diameter, and further wherein each nozzle bore of the plurality of nozzle bores is sized such that each nozzle bore of the plurality of nozzle bores allows a substantially uniform flow rate of a melt material.

2. The perforated plate of claim 1, wherein the length of each nozzle bore of the plurality of nozzle bores is determined using a three-dimensional simulation, wherein the three-dimensional simulation utilizes computational fluid dynamics.

3. The perforated plate of claim 1, wherein:
a. the perforated plate comprises a plurality of nozzle nests, wherein each nozzle nest of the plurality of nozzle nests is arranged on the circumference of at least one constituent circle of the perforated plate; and
b. each nozzle nest of the plurality of nozzle nests comprises the plurality of nozzle bores, wherein each nozzle bore of the plurality of nozzle bores has a substantially similar bore diameter;

4. The perforated plate of claim 3, wherein each nozzle bore of the plurality of nozzle bores has a diameter of less than 1.0 millimeter.

5. A computer-implemented method for determining a length of a nozzle bore for a perforated plate for producing granulate or microgranulate out of a thermoplastic plastic material, wherein the perforated plate comprises a plurality of nozzle bores, including the following steps:
a. creating a model that describes the perforated plate at least in a region of a subset of the plurality of nozzle bores;
b. presetting operating parameters for at least one desired operating state;
c. executing a computer-implemented calculation or a simulation of a flow of melt material through the region of a subset of the plurality of nozzle bores by using the model in order to determine a flow rate of melt material for each nozzle bore of the subset of the plurality of nozzle bores; and
d. changing the lengths of each nozzle bore of the subset of the plurality of nozzle bores in order to produce a substantially uniform flow rate.

6. The computer-implemented method of claim 5, wherein the computer-implemented calculation or the simulation of a flow of melt material comprises a three-dimensional simulation using computational fluid dynamics.

7. The computer-implemented method of claim 5, wherein the model describes a geometry and at least one material property relating to thermal transmission of the perforated plate, at least in the region of the subset of the plurality of nozzle bores.

8. The computer-implemented method of claim 5, wherein the operating parameters comprise at least one of:
a. a viscosity of the melt material;
b. a temperature of the melt material in a vicinity of a supply line;
c. a perforated plate heating temperature; and
d. a cooling fluid temperature.

9. The computer-implemented method of claim 5, wherein a flow rate of melt material through a specific nozzle bore is calculated using a determined speed of melt material flow through the specific nozzle bore.

10. The computer-implemented method of claim 5, wherein the flow rate of melt material for each nozzle bore of the subset of the plurality of nozzle bores is compared to a reference value and the length of each nozzle bore of the subset of the plurality of nozzle bores is changed if the flow rate deviates from the reference value by more than a predetermined amount, wherein the reference value is at least one of:
a. a predetermined setpoint value;
b. a flow rate of melt material through a reference nozzle bore; and
c. an average of the flow rate of melt material through the subset of the plurality of nozzle bores.

11. The computer-implemented method of claim 5, wherein the length of each nozzle bore of the subset of the plurality of nozzle bores is reduced if the flow rate of melt material is less than a reference value.

12. The computer-implemented method of claim 11, wherein the length of each nozzle bore of the subset of the plurality of nozzle bores is reduced by a predetermined increment.

13. The computer-implemented method of claim 5, wherein:
a. the perforated plate comprises a plurality of nozzle nests, wherein each nozzle nest of the plurality of nozzle nests is arranged on the circumference of at least one constituent circle of the perforated plate; and
b. the subset of the plurality of nozzle bores comprises at least one nozzle nest.

14. The computer-implemented method of claim 5, further comprising:
a. determining a quality criterion, wherein the quality criterion is representative of a deviation of the flow rate of melt material through the subset of nozzle bores, wherein the quality criterion is based on at least one of:
(i) a minimum value of the flow rate of melt material for each nozzle bore of the subset of the plurality of nozzle bores;
(ii) a maximum value of the flow rate of melt material for each nozzle bore of the subset of the plurality of nozzle bores;
(iii) a difference between the minimum value and the maximum value of flow rate of melt material for each nozzle bore of the subset of the plurality of nozzle bores as determined by the computer-implemented calculation or the simulation; or
(iv) a sum of the squares of the differences of flow rate of melt material for each nozzle bore of the subset of the plurality of nozzle bores as determined by the computer-implemented calculation or the simulation from an average flow rate of melt material; and
wherein the steps of executing the computer-implemented calculation or the simulation and changing the lengths of each nozzle bore of the subset of the plurality of nozzle bores in order to produce a substantially uniform flow rate are repeated until the quality criterion fulfils a predetermined condition.

15. The perforated plate of claim 1, wherein a nozzle length for each nozzle bore of the subset of the plurality of nozzle bores is determined by:
a. creating a model that describes the perforated plate at least in a region of a subset of the plurality of nozzle bores;
b. presetting operating parameters for at least one desired operating state;
c. executing a computer-implemented calculation or a simulation of a flow of melt material through the region of a subset of the plurality of nozzle bores by using the model in order to determine a flow rate of melt material for each nozzle bore of the subset of the plurality of nozzle bores; and
d. changing the length of each nozzle bore of the subset of the plurality of nozzle bores in order to produce a substantially uniform flow rate.

16. A method for manufacturing a perforated plate for producing granulate or microgranulate from a thermoplastic plastic material, including the following steps:
a. producing a perforated plate structure;
b. determining nozzle bore lengths for a subset of a plurality of nozzle bores by
(i) creating a model that describes the perforated plate at least in a region of a subset of the plurality of nozzle bores;
(ii) presetting operating parameters for at least one desired operating state;
(iii) executing a computer-implemented calculation or a simulation of a flow of melt material through the region of a subset of the plurality of nozzle bores by using the model in order to determine a flow rate of melt material for each nozzle bore of the subset of the plurality of nozzle bores; and
(iv) changing the lengths of each nozzle bore of the subset of the plurality of nozzle bores in order to produce a substantially uniform flow rate
c. producing the perforated plate comprising the determined nozzle bore lengths.

17. A hot-cut granulating device, comprising a perforated plate for producing a granulate or a microgranulate from a thermoplastic plastic material comprising a plurality of nozzle bores, wherein each nozzle bore of the plurality of nozzle bores comprises a substantially uniform bore diameter, and further wherein each nozzle bore of the plurality of nozzle bores is sized such that each nozzle bore of the plurality of nozzle bores allows a substantially uniform flow rate of a melt material.

18. The hot-cut granulating device of claim 17, wherein the perforated plate is produced by:
(i) producing a perforated plate structure;
(ii) determining nozzle bore lengths for a subset of a plurality of nozzle bores by
(1) creating a model that describes the perforated plate at least in a region of a subset of the plurality of nozzle bores;
(2) presetting operating parameters for at least one desired operating state;
(3) executing a computer-implemented calculation or a simulation of a flow of melt material through the region of a subset of the plurality of nozzle bores by using the model in order to determine a flow rate of melt material for each nozzle bore of the subset of the plurality of nozzle bores; and
(iii) changing the lengths of each nozzle bore of the subset of the plurality of nozzle bores in order to produce a substantially uniform flow rate
(iv) producing the perforated plate comprising the determined nozzle bore lengths.

19. The hot-cut granulating device of claim 18, further comprising: determining the nozzle length for each nozzle bore of the subset of the plurality of nozzle bores by:
a. determining a quality criterion, wherein the quality criterion is representative of a deviation of the flow rate of melt material through the subset of nozzle bores, wherein the quality criterion is based on at least one of:
(i) a minimum value of the flow rate of melt material for each nozzle bore of the subset of the plurality of nozzle bores;
(ii) a maximum value of the flow rate of melt material for each nozzle bore of the subset of the plurality of nozzle bores;
(iii) a difference between the minimum value and the maximum value of flow rate of melt material for each nozzle bore of the subset of the plurality of nozzle bores as determined by the computer-implemented calculation or the simulation; or
(iv) a sum of the squares of the differences of flow rate of melt material for each nozzle bore of the subset of the plurality of nozzle bores as determined by the computer-implemented calculation or the simulation from an average flow rate of melt material; and
wherein the steps of executing the computer-implemented calculation or the simulation and changing the lengths of each nozzle bore of the subset of the plurality of nozzle bores in order to produce a substantially uniform flow rate are repeated until the quality criterion fulfils a predetermined condition.
